(19) United States
(12) Patent Application Publication
(10) Pub. No.: US 2013/0256364 A1
(43) Pub. Date: Oct. 3, 2013

(54) FASTENER DRIVER HAVING WASHER FEEDING DEVICE

(71) Applicant: Shun Ping YAO, Taichung (TW)

(72) Inventor: Shun Ping YAO, Taichung (TW)

(21) Appl. No.: 13/432,032

(22) Filed: Mar. 28, 2012

(51) Int. Cl. B25C 5/16; B25C 7/00

(52) U.S. Cl. 227/18

(57) ABSTRACT

A fastener driver includes a driver body member having a cassette for accommodating staples, and a washer carrying device having a housing attached to the driver body member, and the housing includes a chamber for receiving washers, a mouth piece attached to the housing and having an opening formed in the mouth piece and aligned with the nose portion of the driver body member for selectively receiving the washers, and a pushing device slidably attached to the housing for moving the washers toward the mouth piece and the nose section of the fastener driver and for allowing the washers to be suitably engaged with the nails or fasteners that are hammered or driven by the ejector.

### BACKGROUND OF THE INVENTION

1. Field of the Invention

The present invention relates to a nail or fastener driver, and more particularly to a nail or fastener driver including a washer holding and carrying and feeding device for receiving or accommodating a number of washers and for suitably and smoothly feeding or supplying the washers toward the nose section of the fastener driver and for allowing the washers to be suitably engaged with the nails or fasteners that are hammered or driven by the ejector.

2. Description of the Prior Art

Typical staplers or nail or fastener drivers or driving machines comprise a magazine attached or mounted or secured to a lower or bottom portion of a driving machine body for receiving or accommodating a number of nails or fasteners, and an ejector or hammering or driving mechanism attached or mounted or secured to a front portion of the driving machine body for hammering or driving the nails or fasteners into work pieces.

For preventing the nails or fasteners from being deeply hammered or driven or engaged into the work pieces, some of the typical staplers or nail or fastener drivers or driving machines have been developed to provide a washer holding and carrying and feeding device for receiving or accommodating a number of washers and for feeding or supplying the washers toward the nose section of the fastener driver and for allowing the washers to be engaged with the nails or fasteners that are hammered or driven by the ejector or driving mechanism.

For example, U.S. Pat. No. 6,471,107 to Liu et al., U.S. Pat. No. 6,481,610 to Liu et al., and U.S. Pat. No. 6,908,022 to Schmitz disclose several of the typical staplers or nail or fastener drivers or driving machines each also comprising a washer holding and carrying and feeding device for receiving or accommodating a number of washers and for feeding or supplying the washers toward the nose section of the fastener driver and for allowing the washers to be engaged with the nails or fasteners that are hammered or driven by the ejector or driving mechanism.

However, the washer holding and carrying and feeding device for the typical staplers or nail or fastener drivers or driving machines may only be used to receive or accommodate few lines of washers or few number of washers, such that the users have to refill the washers very often.

The present invention has arisen to mitigate and/or obviate the afore-described disadvantages of the conventional washer holding and carrying and feeding devices for fastener drivers.

### SUMMARY OF THE INVENTION

The primary objective of the present invention is to provide a fastener driver including a washer holding and carrying and feeding device for receiving or accommodating a number of washers and for suitably and smoothly feeding or supplying the washers toward the nose section of the fastener driver and for allowing the washers to be suitably engaged with the nails or fasteners that are hammered or driven by the ejector.

In accordance with one aspect of the invention, there is provided a fastener driver comprising a driver body member including a handle for being grasped by a user, and including a cassette for accommodating staples and for supplying the staples toward a nose portion of the driver body member, and the driver body member including a tail portion, and a washer carrying device including a housing attached to the driver body member, and the housing including a chamber formed therein for receiving washers, and including two side walls and a bottom wall for forming the chamber of the housing, a mouth piece attached to the housing and having an opening formed in the mouth piece and aligned with the nose portion of the driver body member for selectively receiving the washers, and a pushing device slidably attached to the housing for engaging with the washers and for moving the washers to move toward the mouth piece.

The housing includes a front portion, and an end piece attached to the front portion of the housing and having an opening formed therein and aligned with the opening of the mouth piece, and the end piece includes a passageway formed therein and communicative with the opening of the end piece for allowing the washers to be supplied into the opening of the end piece.

An anchoring member is further provided and slidably attached to the mouth piece and includes a lower end engageable into the passageway of the end piece for selectively engaging with the washers. The anchoring member includes a stop member for selectively engaging with the mouth piece and for limiting the anchoring member to move relative to the mouth piece.

The mouth piece includes an orifice formed therein for slidably engaging with the anchoring member, and includes a shallow depression and a deep depression formed therein, the anchoring member includes a projection extended therefrom for selectively engaging with either of the depressions of the mouth piece, and for allowing the lower end of the anchoring member to be selectively engaged into the passageway of the end piece when the projection is engaged with the deep depression, and for preventing the lower end of the anchoring member from being engaged into the passageway of the end piece when the projection is engaged with the shallow depression of the mouth piece.

The mouth piece includes a spring biasing member engaged with the anchoring member for biasing and forcing the lower end of the anchoring member to move into the passageway of the end piece. The spring biasing member includes a notch formed therein for receiving and engaging with the anchoring member.

The housing includes a passage formed in the bottom wall of the housing and communicative with the chamber of the housing, the pushing device includes a pushing member slidably attached to the housing and includes a tongue engageable through the passage of the bottom wall of the housing and engageable into the chamber of the housing for engaging with the washers.

The tongue is pivotally attached to the pushing member with a pivot pin, and a spring biasing member is engaged between the pushing member and the tongue for forcing the tongue to engage with the washers. The pushing device includes a knob extended from the pushing member for moving the pushing member along the bottom wall of the housing.

The housing includes a guide slot and a guide pathway formed therein, and the pushing member includes two ribs extended therefrom for slidably engaging with the guide slot and the guide pathway of the housing respectively and for slidably attaching the pushing member to the housing. The housing includes a spring biasing member engaged between the pushing device and the housing for biasing the pushing device toward the mouth piece.

The housing includes a retaining device engaged with the washers for moving the washers to move toward the bottom wall of the housing. The retaining device includes a pressing member received in the chamber of the housing and engaged with the washers for depressing and moving the washers to move downwardly toward the bottom wall of the housing.

The retaining device includes a spring biasing member engaged with the pressing member. The housing includes an upper wall having a guide channel formed therein and communicative with the chamber of the housing for receiving the spring biasing member. The retaining device includes a casing disposed on the upper wall of the housing and having a compartment formed therein for engaging with the spring biasing member.

The spring biasing member is attached to the casing with a fastener, and includes two legs extended through the guide channel of the housing and extended into the chamber of the housing and engaged with the pressing member. The retaining device includes two spring blades attached to the casing for selectively engaging with the housing and for resiliently clamping and retaining the casing to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a fastener driver having a washer holding and carrying and feeding device in accordance with the present invention;

FIG. 2 is an upper perspective view of the washer holding and carrying and feeding device for the fastener driver;

FIG. 3 is a bottom perspective view of the washer holding and carrying and feeding device for the fastener driver;

FIG. 4 is an exploded view of the washer holding and carrying and feeding device for the fastener driver;

FIG. 5 is a cross sectional view of the washer holding and carrying and feeding device for the fastener drive, taken along lines 5-5 of FIG. 2;

FIGS. 6, 7 are cross sectional views similar to FIG. 5, illustrating the operation of the washer holding and carrying and feeding device for the fastener driver;

FIG. 8 is an enlarged partial cross sectional view of the washer holding and carrying and feeding device for the fastener drive;

FIGS. 9, 10 are partial cross sectional views similar to FIG. 8, illustrating the operation of the washer holding and carrying and feeding device for the fastener driver;

FIG. 11 is an enlarged partial perspective view of the washer holding and carrying and feeding device for the fastener driver, in which one half of the washer holding and carrying and feeding device has been cut off for showing the inner structure of the washer holding and carrying and feeding device;

FIG. 12 is a partial exploded view of the washer holding and carrying and feeding device for the fastener driver;

FIG. 13 is a partial perspective view of the washer holding and carrying and feeding device as shown in FIG. 12; and

FIGS. 14, 15, 16 are partial exploded views illustrating the attachment or engagement of the washers into the washer holding and carrying and feeding device for the fastener driver.

### DETAILED DESCRIPTION OF THE PREFERRED EMBODIMENT

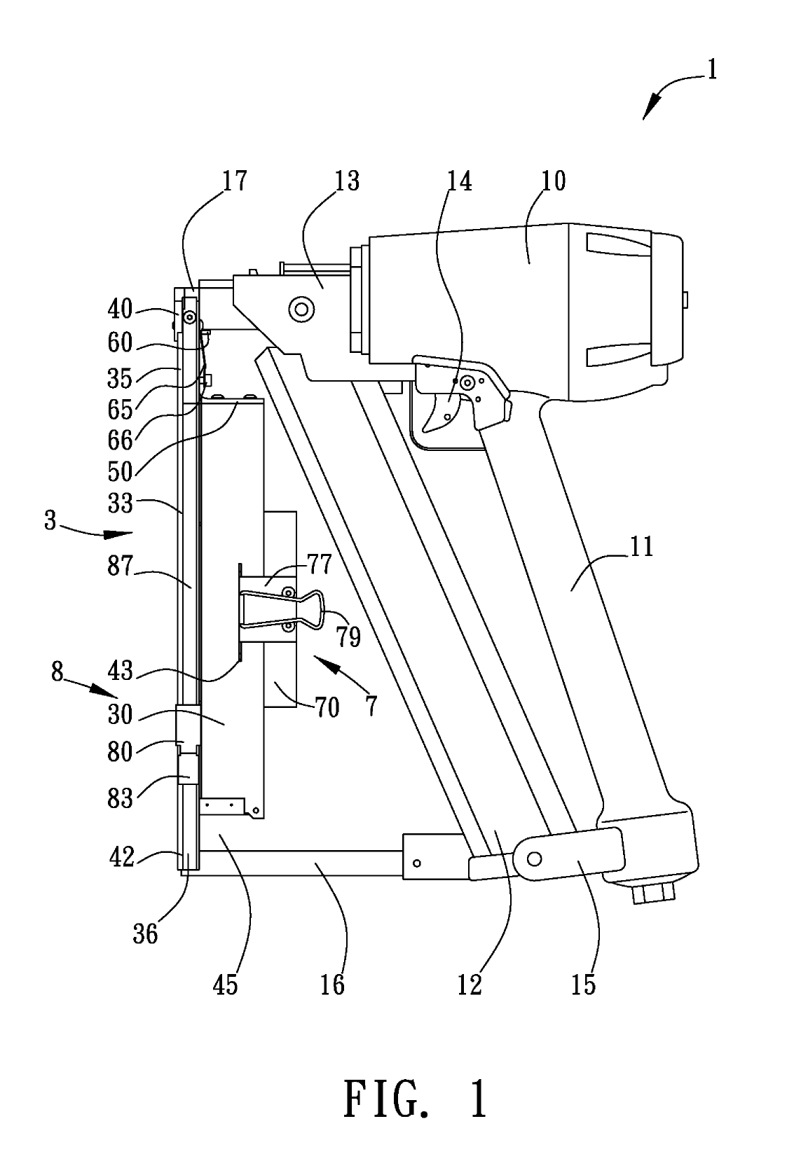

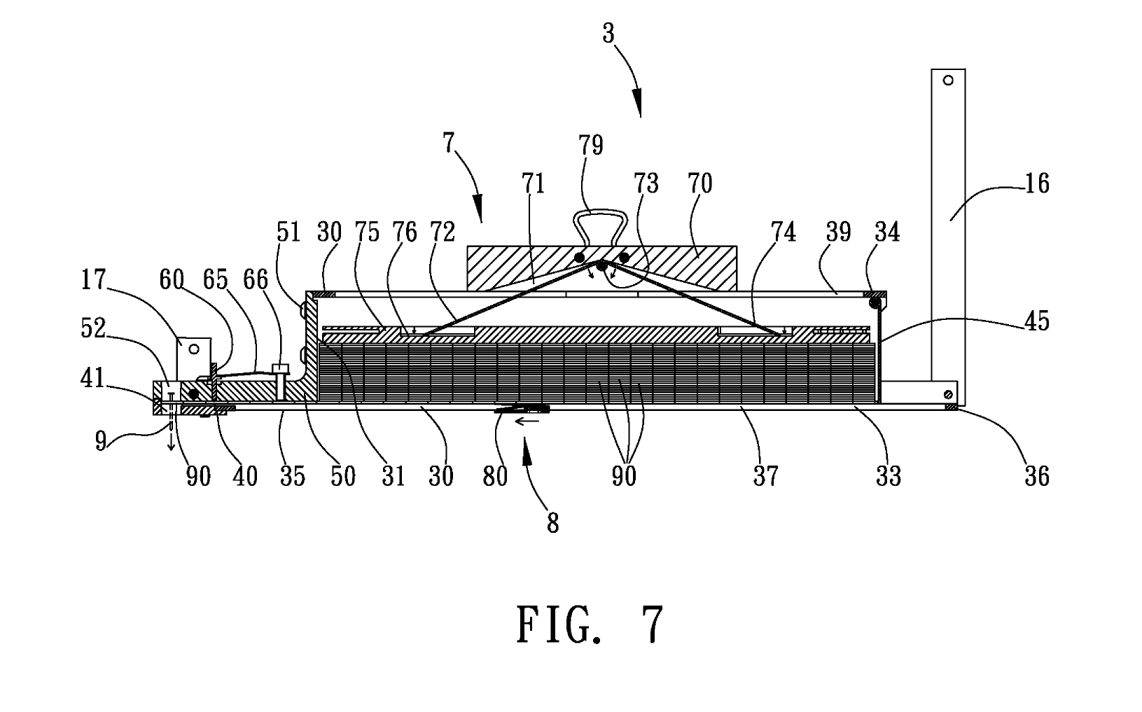

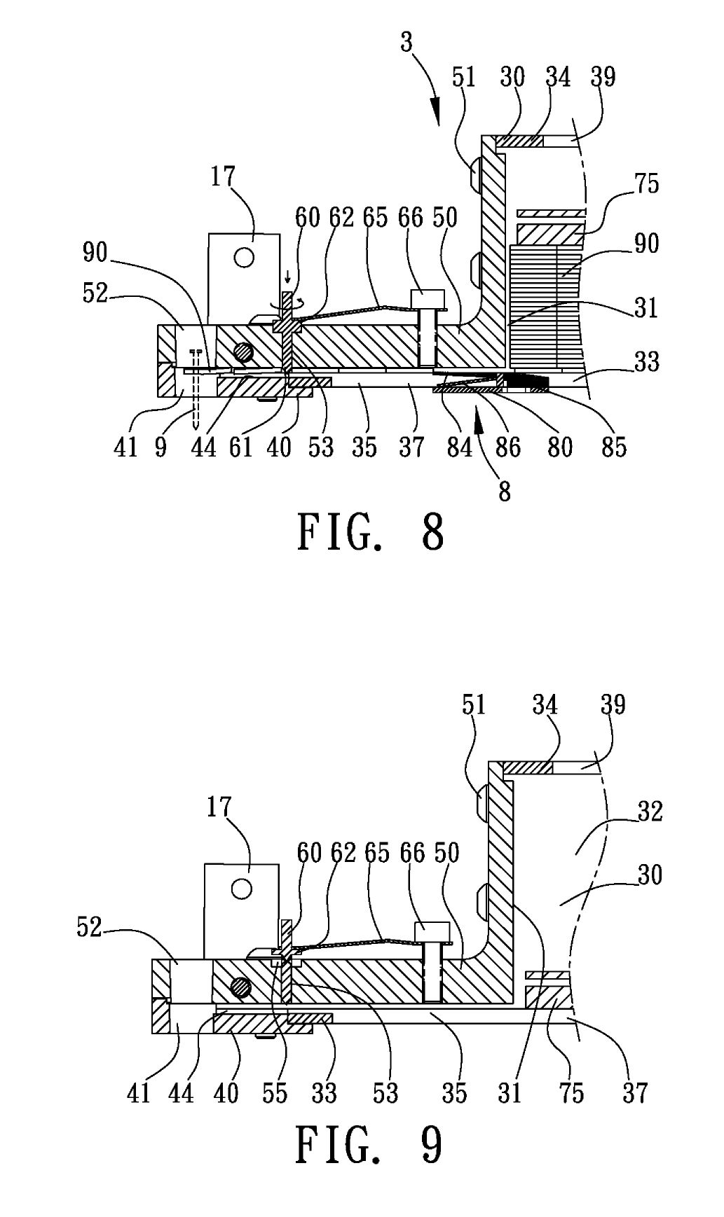

Referring to the drawings, and initially to FIG. 1, a nail or staple or fastener driver 1 in accordance with the present invention comprises a gun or driver member or body member 10 including a handle 11 for being grasped or held by the user, and including a cassette 12 attached or mounted or secured or coupled thereto, such as attached to the bottom or lower portion thereof for receiving or holding or carrying or accommodating the nails or staples or fasteners 9 (FIGS. 7-8) and for feeding or supplying the nails or staples or fasteners 9 toward the nose portion 13 of the driver member or body member 10, and including a trigger 14 attached or mounted or secured or coupled thereto, such as attached to the adjacent or abutting portion of the driver body member 10 and the handle 11 for being pulled or operated or actuated by the user.

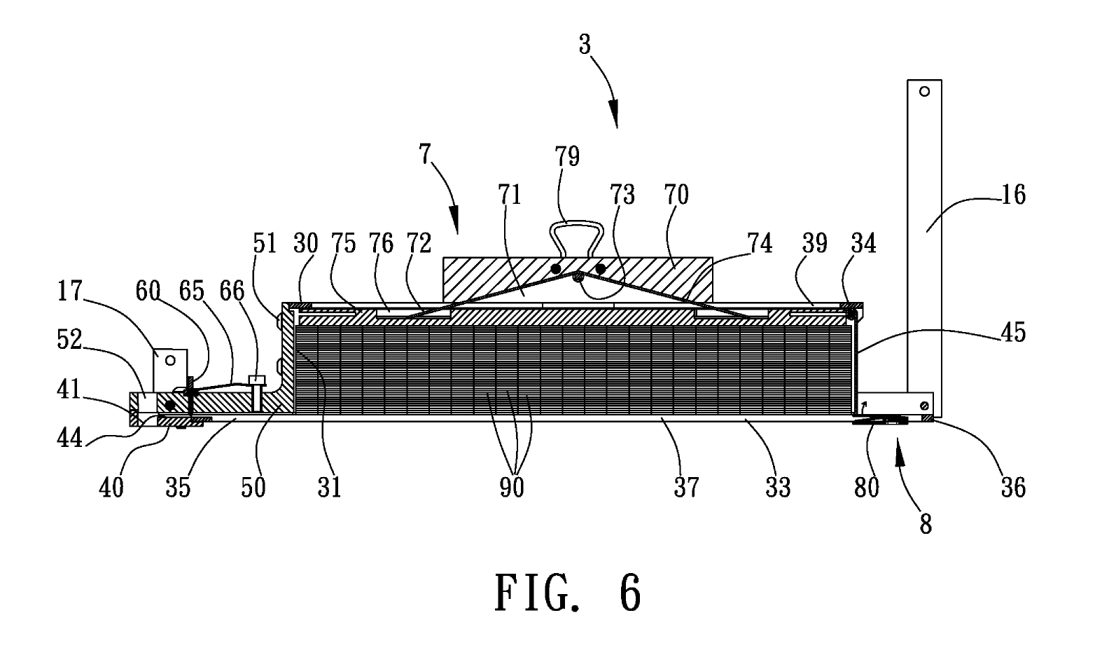

In operation, the trigger 14 may be pulled or operated or actuated by the user to actuate or operate or force a driver bit or shaft (not shown) to hammer or strike or push or force the nails or staples or fasteners 9 out through the nose portion 13 of the driver body member 10. The above-described structure or configuration for the driver body member 10 and the cassette 12 is typical and is not related to the present invention and will not be described in further details. The staple or fastener driver 1 in accordance with the present invention further comprises a washer holding and carrying and feeding device 3 attached or mounted or secured or coupled to the driver body member 10 and/or the cassette 12 for receiving or holding or carrying or accommodating the washers 90 (FIGS. 6-8, 14, 16) and for feeding or supplying the washers 90 toward the nose portion 13 of the driver body member 10.

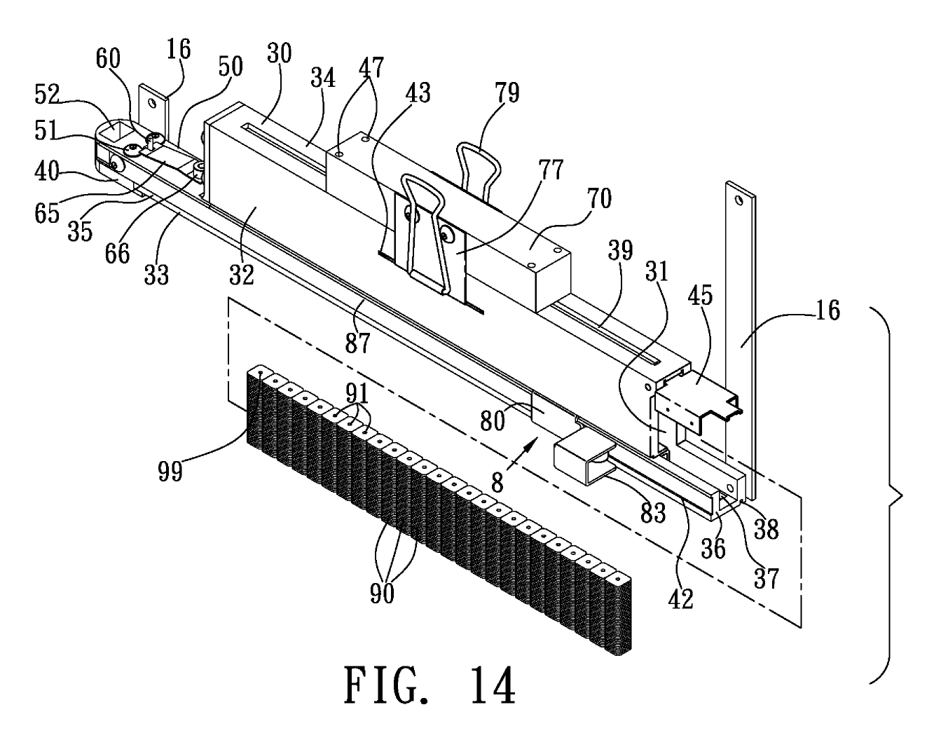

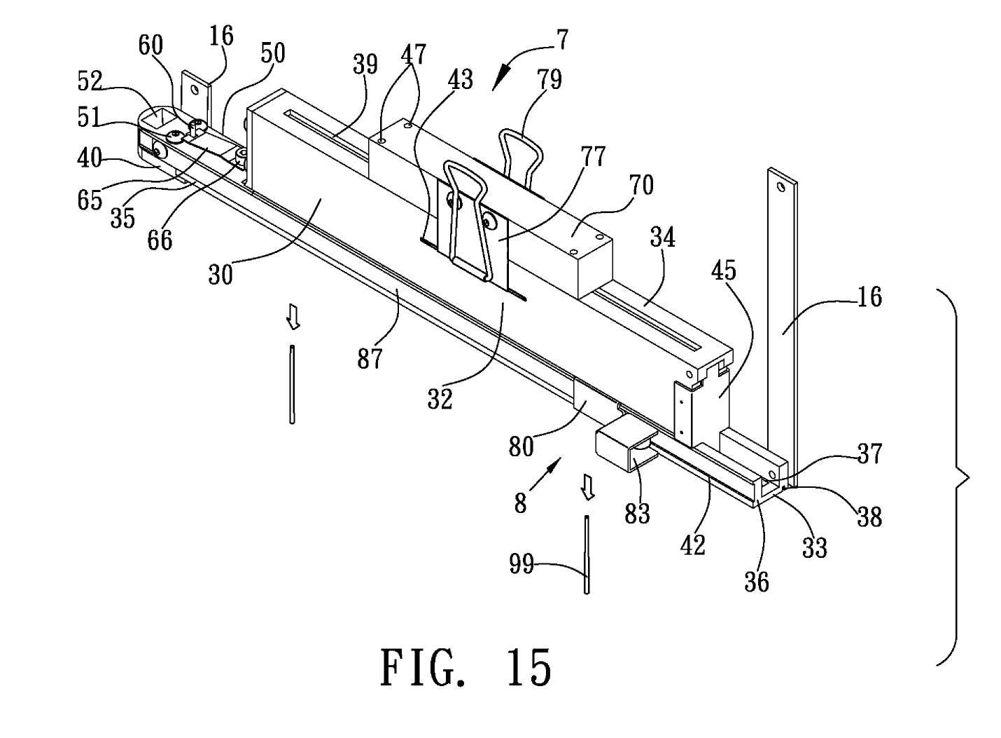

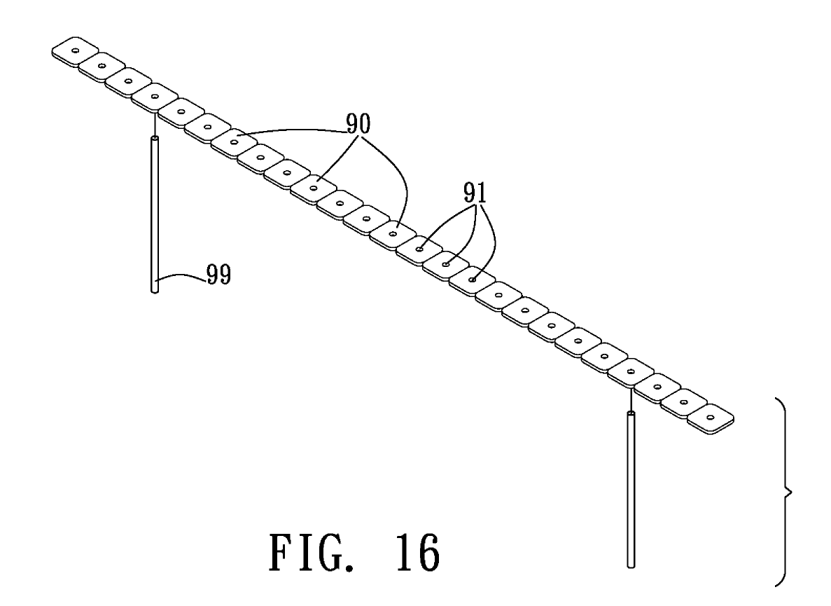

For example, the washer holding and carrying and feeding device 3 includes a rear or tail or lower portion attached or mounted or secured or coupled to the rear or lower or tail portion 15 of the driver body member 10 and/or of the cassette 12 with a link member 16, and includes a front or upper portion attached or mounted or secured or coupled to the front or upper or nose portion 13 of the driver body member 10 with another link member 17, and the washer holding and carrying and feeding device 3 is provided for feeding or supplying the washers 90 toward the nose portion 13 of the driver body member 10, and arranged for allowing the nails or staples or fasteners 9 to be engaged through the holes 91 (FIGS. 14, 16) of the washers 90 (FIGS. 7-8).

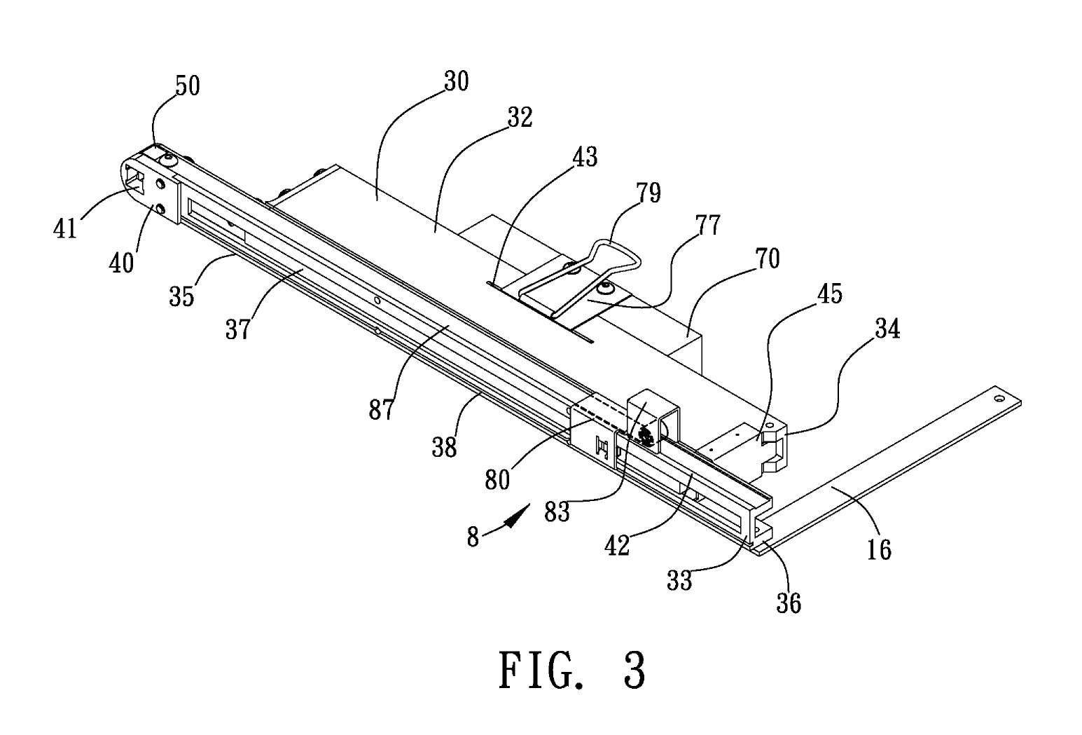

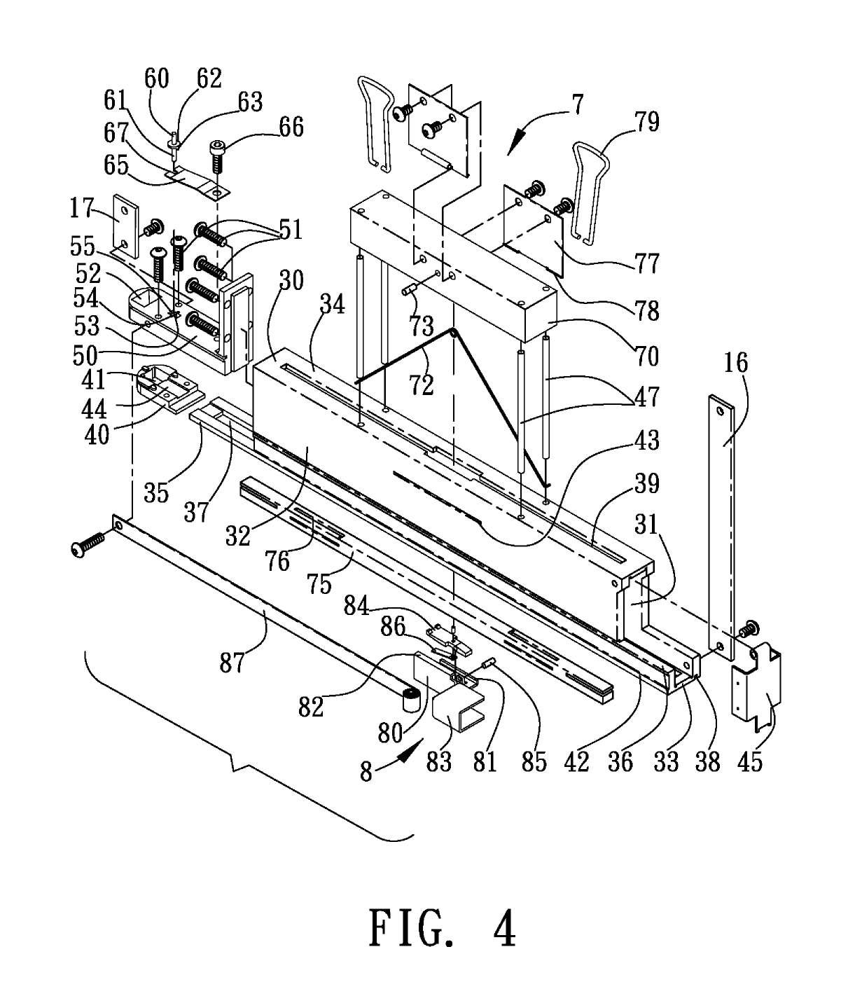

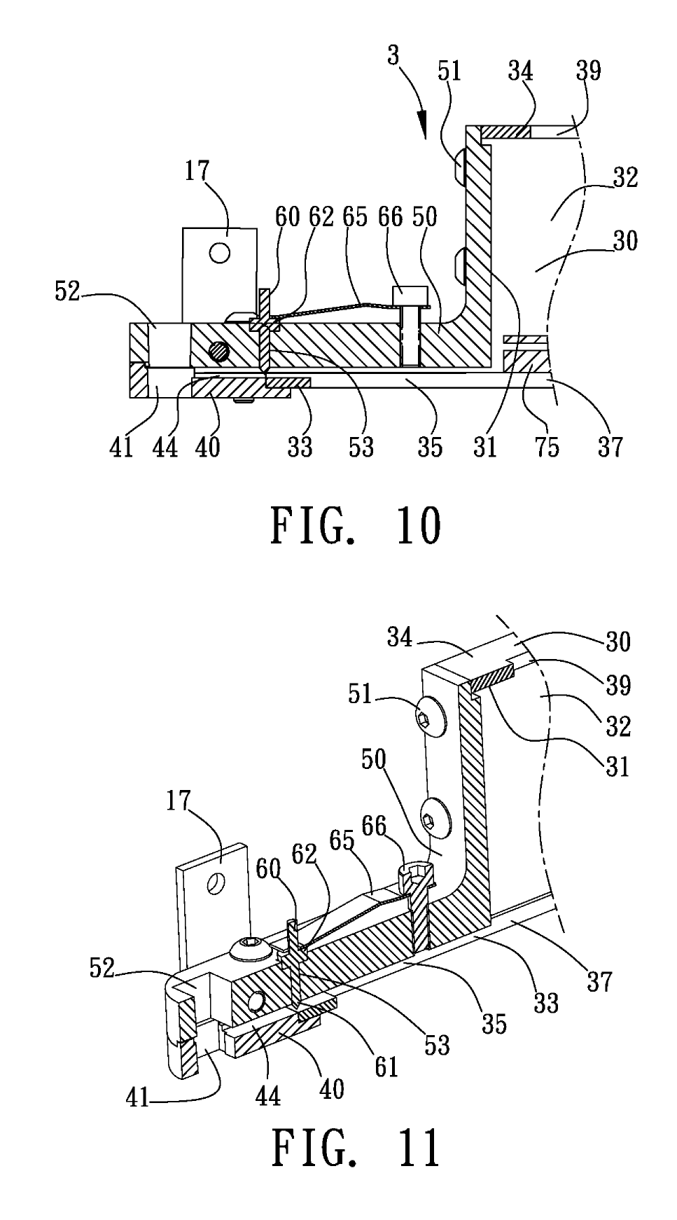

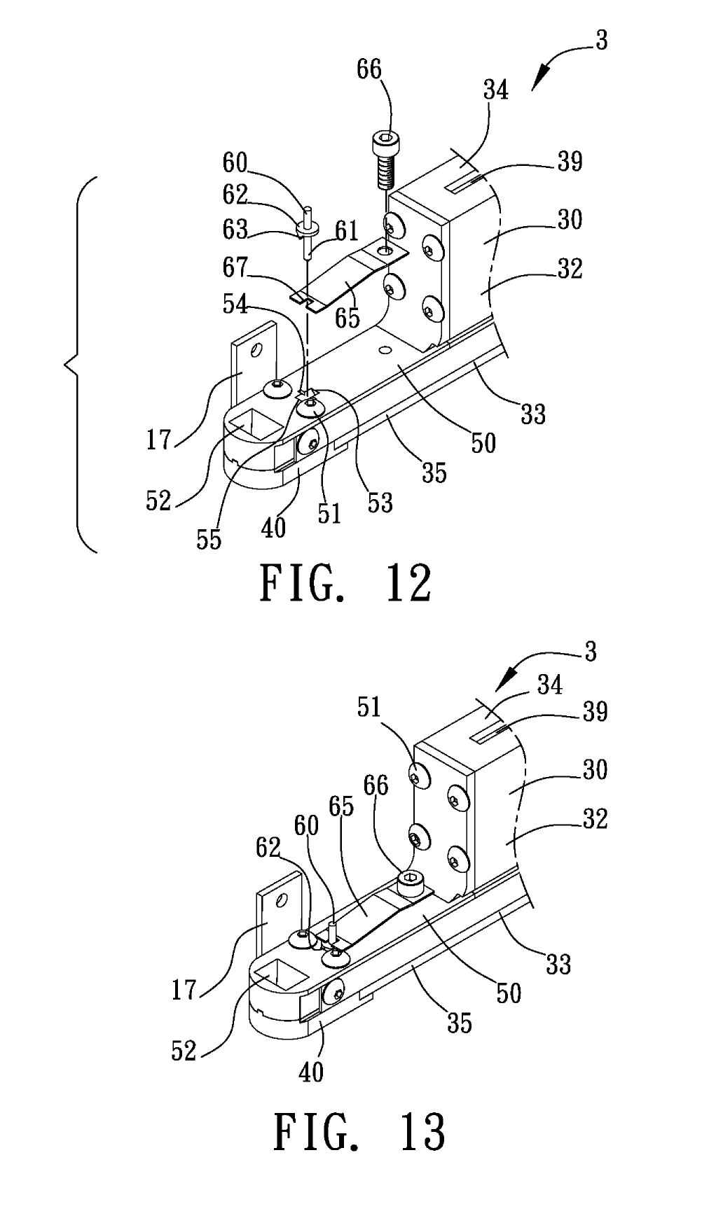

As shown in FIGS. 1-15, the washer holding and carrying and feeding device 3 includes a track or guide rail or housing 30 having a chamber 31 formed therein (FIGS. 4-10) and formed or defined by two side walls 32, a bottom wall 33, and an upper wall 34 for receiving or holding or carrying or accommodating the washers 90 therein (FIGS. 6-8), the bottom wall 33 includes a front portion 35 extended forwardly and out of the housing 30, and includes a rear portion 36 extended rearwardly and out of the housing 30, and includes a passage 37 formed therein and communicative with the chamber 31 of the housing 30, and includes a guide slot 38 formed therein (FIG. 3), such as formed in the bottom portion thereof and located beside and parallel to the passage 37 of the bottom wall 33 of the housing 30.

An end piece 40 is attached or mounted or secured or coupled to the front portion 35 of the bottom wall 33 or of the housing 30, and includes an opening 41 formed therein and aligned with the nose portion 13 and/or the ejector (not shown) of the driver body member 10 for selectively receiving or engaging with the washers 90 and the nails or staples or fasteners 9 (FIGS. 8-9). The upper wall 34 of the housing 30 includes a longitudinal guide channel 39 formed therein and communicative with the chamber 31 of the housing 30, and the housing 30 includes a longitudinal guide pathway 42 formed therein (FIG. 3), such as formed in the bottom wall 33 and/or formed in one of the side walls 32, and includes a groove 43 formed in each of the side walls 32.

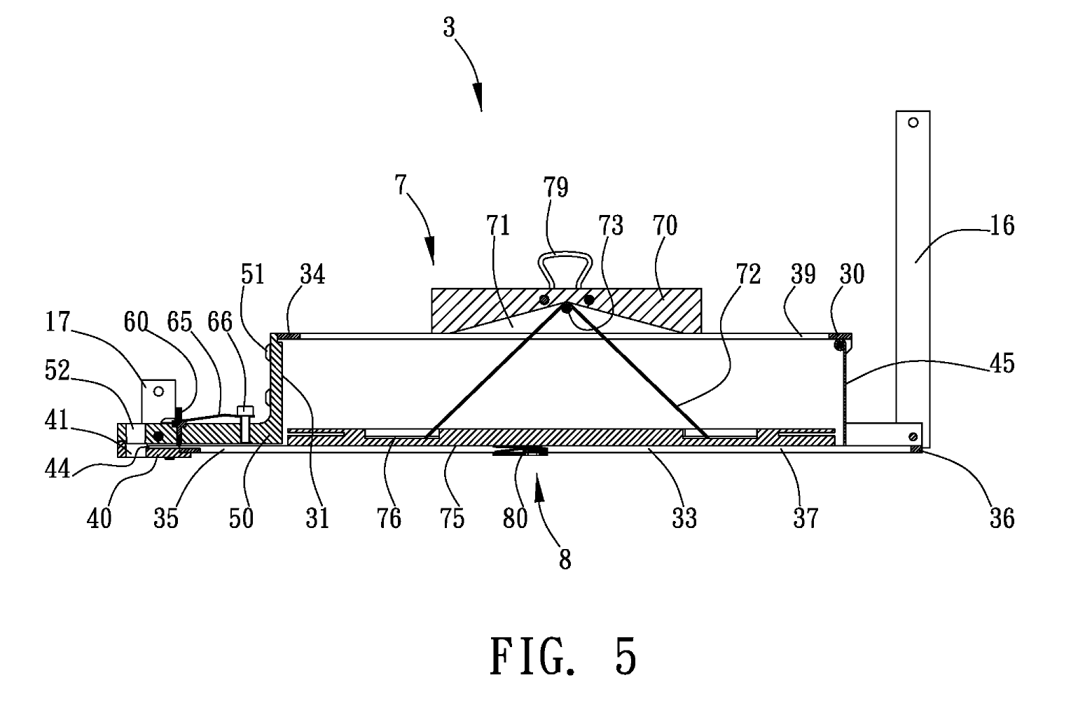

A base or seat or bracket or mouth piece 50 is attached or mounted or secured or coupled to the front portion 35 of the bottom wall 33 or of the housing 30, and/or to the end piece 40, and/or to the housing 30 with latches or fasteners 51 or the like, and also includes an opening 52 formed therein and aligned with the nose portion 13 and/or the ejector (not shown) of the driver body member 10 and also aligned with the opening 41 of the end piece 40 (FIGS. 5-11) for selectively receiving or engaging with the washers 90 and the nails or staples or fasteners 9. As shown in FIGS. 4-11, the mouth piece 50 and/or the end piece 40 includes a depression or passageway 44 formed therein and communicative with the opening 52 of the mouth piece 50 and/or the opening 41 of the end piece 40 for allowing the washers 90 to be sent or supplied into the opening 52 of the mouth piece 50 and/or the opening 41 of the end piece 40 one by one (FIGS. 7, 8).

As shown in FIGS. 4 and 8-12, the mouth piece 50 includes an orifice 53 formed therein and communicative with the opening 52 of the mouth piece 50 and/or the opening 41 of the end piece 40 for slidably receiving or engaging with an anchoring member 60 which includes a lower end 61 extendible or engageable into the passageway 44 of the end piece 40 or of the mouth piece 50 for selectively engaging with the washers 90 (FIG. 8) and for limiting or retaining or guiding the washers 90 to move into the opening 52 of the mouth piece 50 and/or the opening 41 of the end piece 40 one by one. A pivotal or foldable or openable cover 45 is pivotally or rotatably attached or mounted or secured to the rear portion 36 of the bottom wall 33 or of the housing 30 for openably enclosing the rear portion of the chamber 31 of the housing 30 and for anchoring or confining or retaining the washers 90 within the chamber 31 of the housing 30.

The mouth piece 50 includes a shallower depression 54 and a deeper depression 55 formed therein and located beside the orifice 53 of the mouth piece 50. The anchoring member 60 includes an enlarged peripheral flange or stop member 62 extended radially and outwardly therefrom for selectively engaging with the mouth piece 50 and for limiting or guiding the anchoring member 60 to move relative to the mouth piece 50, and includes a key or peg or projection 63 extended therefrom, such as extended from the enlarged stop member 62 of the anchoring member 60 for selectively engaging with the depressions 54, 55 of the mouth piece 50, and for allowing the lower end 61 of the anchoring member 60 to be selectively engaged into the passageway 44 of the end piece 40 when the projection 63 is engaged with the deeper depression 55 (FIGS. 5-6, 8, 10-11), and for preventing the lower end 61 of the anchoring member 60 from being engaged into the passageway 44 of the end piece 40 when the projection 63 is engaged with the shallower depression 54 of the mouth piece 50 (FIGS. 7, 9).

A spring biasing member 65 is attached or mounted or secured to the mouth piece 50 with one or more latches or fasteners 66 or the like, and includes a notch 67 formed therein for receiving or engaging with the anchoring member 60 and for applying a spring biasing force onto the anchoring member 60 and for biasing or forcing the lower end 61 of the anchoring member 60 to move into the passageway 44 of the end piece 40, and to bias and force the lower end 61 of the anchoring member 60 to selectively engage with the washers 90. One or more (such as two) rods or poles 99 (FIGS. 14-16) may be engaged through the holes 91 of the washers 90 (FIGS. 14, 16) for arranging and moving or engaging the washers 90 into the chamber 31 of the housing 30, and may then be removed or disengaged from the washers 90 and the housing 30 from the passage 37 of the bottom wall 33 of the housing 30 (FIG. 15).

A forcing or retaining device 7 may further be provided for engaging with the washers 90 and for biasing or forcing the washers 90 to move downwardly toward the bottom wall 33 of the housing 30. For example, the retaining device 7 includes a casing 70 disposed or attached or mounted or secured onto the upper wall 34 of the housing 30 with one or more fasteners or latches 47 or the like, and includes a compartment 71 formed therein (FIGS. 5-7) for receiving or engaging with another spring biasing member 72 which may be attached or mounted or secured to the casing 70 with one or more latches or fasteners 73 or the like, the spring biasing member 72 includes two limbs or ends or legs 74 extended through the channel 39 of the housing 30 and extended into the chamber 31 of the housing 30. A bar or pressing member 75 is disposed or received or engaged in the chamber 31 of the housing 30 and engaged with the washers 90 for depressing the washers 90 to move downwardly toward the bottom wall 33 of the housing 30.

The pressing member 75 includes two slots 76 formed therein for slidably receiving or engaging with the legs 74 of the spring biasing member 72 and for allowing the spring biasing member 72 to bias or force or depress the pressing member 75 and then to move the washers 90 downwardly toward the bottom wall 33 of the housing 30. One or more (such as two) further spring biasing members or spring blades 77 may further be provided and attached or mounted or secured to the casing 70, and each include a peg or key or protrusion 78 extended therefrom (FIG. 4) for selectively engaging with the groove 43 of the housing 30 and for resiliently clamping or anchoring or securing or retaining the casing 70 to the housing 30, and two handles or hand grips 79 attached or mounted or secured to the spring blades 77 for selectively removing or disengaging the protrusions 78 of the spring blades 77 from the groove 43 of the housing 30 and for allowing the casing 70 to be easily and quickly and readily attached or mounted or secured to the housing 30.

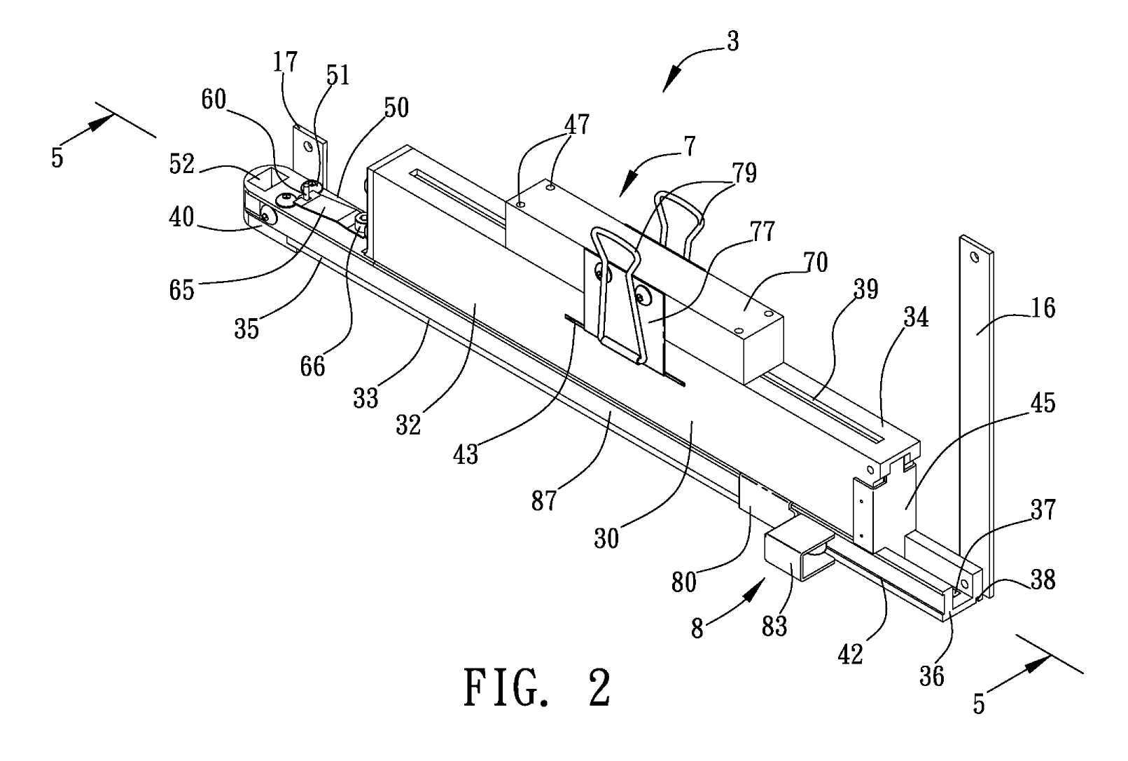

As shown in FIGS. 2-8, a pusher or pushing device 8 is further provided or attached or mounted or secured to the housing 30 for engaging with the washers 90 and for forcing or moving the washers 90 to move toward the end piece 40 and the mouth piece 50, and includes a housing or casing or pushing member 80 slidably attached or mounted or secured to the housing 30, such as attached to the bottom wall 33 of the housing 30 and slidable along the bottom wall 33 of the housing 30. The pushing member 80 includes one or more (such as two) pegs or keys or ribs 81, 82 extended therefrom (FIG. 4) for slidably engaging with the guide slot 38 and the guide pathway 42 of the housing 30 respectively and for slidably attaching or mounting or securing the pushing member 80 to the housing 30.

The pushing member 80 includes a handle or hand grip or knob 83 extended therefrom for moving or sliding the pushing member 80 along the bottom wall 33 of the housing 30. A pushing element or tongue 84 is rotatably or pivotally attached or mounted or secured to the pushing member 80 with a pivot pin 85 (FIGS. 4, 8) and engageable through the passage 37 of the bottom wall 33 of the housing 30 and engageable into the chamber 31 of the housing 30, and engageable with the washers 90 (FIG. 8) for forcing and pushing or moving the washers 90 forwardly toward the end piece 40 and the mouth piece 50. A further spring biasing member 86 is further provided or attached or mounted or secured or coupled or engaged between the pushing member 80 and the tongue 84 for forcing and pushing or biasing the tongue 84 to engage with the washers 90. A still further spring biasing member 87 is further provided or attached or mounted or secured or engaged or coupled between the pushing member 80 and the housing 30 for forcing or pulling or biasing the pushing member 80 toward the end piece 40 and the mouth piece 50.

In operation, as shown in FIGS. 6-8, the spring biasing member 72 may bias or force or depress the pressing member 75 and then may force and move the washers 90 downwardly toward the bottom wall 33 of the housing 30, and the tongue 84 may be forced or biased or moved to engage with the washers 90 by the spring biasing member 87 and to force and move the washers 90 toward the end piece 40 and the mouth piece 50, and into the opening 52 of the mouth piece 50 and/or the opening 41 of the end piece 40, for allowing the nails or staples or fasteners 9 to be engaged through the holes 91 (FIGS. 14, 16) of the washers 90 and then to be hammered or driven or moved out of the end piece 40 and the mouth piece 50 by the ejector. The anchoring member 60 may anchor and limit and guide the washers 90 to move into the opening 52 of the mouth piece 50 and/or the opening 41 of the end piece 40 one by one.

Accordingly, the fastener driver in accordance with the present invention includes a washer holding and carrying and feeding device for receiving or accommodating a number of washers and for suitably and smoothly feeding or supplying the washers toward the nose section of the fastener driver and for allowing the washers to be suitably engaged with the nails or fasteners that are hammered or driven by the ejector.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener driver comprising:
a driver body member including a handle for being grasped by a user, and including a cassette for accommodating staples and for supplying the staples toward a nose portion of said driver body member, and said driver body member including a tail portion, and
a washer carrying device including a housing attached to said driver body member, and said housing including a chamber formed therein for receiving washers, and including two side walls and a bottom wall for forming said chamber of said housing, a mouth piece attached to said housing and having an opening formed in said mouth piece and aligned with said nose portion of said driver body member for selectively receiving the washers, and a pushing device slidably attached to said housing for engaging with the washers and for moving the washers to move toward said mouth piece.

2. The fastener driver as claimed in claim 1, wherein said housing includes a front portion, and an end piece attached to said front portion of said housing and having an opening formed therein and aligned with said opening of said mouth piece, and said end piece includes a passageway formed therein and communicative with said opening of said end piece for allowing the washers to be supplied into said opening of said end piece.

3. The fastener driver as claimed in claim 2, wherein an anchoring member is slidably attached to said mouth piece and includes a lower end engageable into said passageway of said end piece for selectively engaging with the washers.

4. The fastener driver as claimed in claim 3, wherein said mouth piece includes an orifice formed therein for slidably engaging with said anchoring member, and includes a shallow depression and a deep depression formed therein, said anchoring member includes a projection extended therefrom for selectively engaging with either of said depressions of said mouth piece, and for allowing said lower end of said anchoring member to be selectively engaged into said passageway of said end piece when said projection is engaged with said deep depression, and for preventing said lower end of said anchoring member from being engaged into said passageway of said end piece when said projection is engaged with said shallow depression of said mouth piece.

5. The fastener driver as claimed in claim 3, wherein said mouth piece includes a spring biasing member engaged with said anchoring member for biasing and forcing said lower end of said anchoring member to move into said passageway of said end piece.

6. The fastener driver as claimed in claim 5, wherein said spring biasing member includes a notch formed therein for receiving and engaging with said anchoring member.

7. The fastener driver as claimed in claim 3, wherein said anchoring member includes a stop member for selectively engaging with said mouth piece and for limiting said anchoring member to move relative to said mouth piece.

8. The fastener driver as claimed in claim 1, wherein said housing includes a passage formed in said bottom wall of said housing and communicative with said chamber of said housing, said pushing device includes a pushing member slidably attached to said housing and includes a tongue engageable through said passage of said bottom wall of said housing and engageable into said chamber of said housing for engaging with the washers.

9. The fastener driver as claimed in claim 8, wherein said tongue is pivotally attached to said pushing member with a pivot pin, and a spring biasing member is engaged between said pushing member and said tongue for forcing said tongue to engage with the washers.

10. The fastener driver as claimed in claim 8, wherein said pushing device includes a knob extended from said pushing member for moving said pushing member along said bottom wall of said housing.

11. The fastener driver as claimed in claim 8, wherein said housing includes a guide slot and a guide pathway formed therein, and said pushing member includes two ribs extended therefrom for slidably engaging with said guide slot and said guide pathway of said housing respectively and for slidably attaching said pushing member to said housing.

12. The fastener driver as claimed in claim 1, wherein said housing includes a spring biasing member engaged between said pushing device and said housing for biasing said pushing device toward said mouth piece.

13. The fastener driver as claimed in claim 1, wherein said housing includes a retaining device engaged with the washers for moving the washers to move toward said bottom wall of said housing.

14. The fastener driver as claimed in claim 13, wherein said retaining device includes a pressing member received in said chamber of said housing and engaged with the washers for depressing and moving the washers to move downwardly toward said bottom wall of said housing.

15. The fastener driver as claimed in claim 14, wherein said retaining device includes a spring biasing member engaged with said pressing member.

16. The fastener driver as claimed in claim 15, wherein said housing includes an upper wall having a guide channel formed therein and communicative with the chamber of the housing for receiving said spring biasing member.

17. The fastener driver as claimed in claim 16, wherein said retaining device includes a casing disposed on the upper wall of the housing and having a compartment formed therein for engaging with said spring biasing member.

18. The fastener driver as claimed in claim 17, wherein said spring biasing member is attached to said casing with a fastener, and includes two legs extended through said guide channel of said housing and extended into said chamber of said housing and engaged with said pressing member.

19. The fastener driver as claimed in claim 17, wherein said retaining device includes two spring blades attached to said casing for selectively engaging with said housing and for resiliently clamping and retaining said casing to said housing.
